(19) United States
(12) Patent Application Publication
(10) Pub. No.: US 2014/0114794 A1
(43) Pub. Date: Apr. 24, 2014

(54) MOBILE TELEPHONE AUTOMOBILE ACCESSORY SELECTION APPLICATION

(71) Applicant: Glen Wolf, Federal Way, WA (US)

(72) Inventor: Glen Wolf, Federal Way, WA (US)

(21) Appl. No.: 14/060,834

(22) Filed: Oct. 23, 2013

Related U.S. Application Data
(60) Provisional application No. 61/718,123, filed on Oct. 24, 2012.

(51) Int. Cl. G06Q 30/06

(52) U.S. Cl. CPC G06Q 30/0643; G06Q 30/0621
USPC 705/26.5

(57) ABSTRACT

A method for mobile device automobile accessory selection including operating a mobile device to display a plurality of accessory icons on a computer screen, each icon representing a particular automobile upgrade, where each accessory icon has linked information including pricing information that will appear as a pop-up window when activated. A gridded icon with a plurality of grid locations is displayed on the computer screen, where each grid location is adapted to accept a relocated accessory icon, where the gridded icon has the shape of a car overlayed with a representation of a smart phone and the smart phone includes the plurality of grid locations. An accessory icon is selected by relocating it to one of the plurality of grid locations.

### CROSS-REFERENCE TO RELATED APPLICATION

This application is a non-provisional application of currently co-pending U.S. Provisional Patent Application No. 61/718,123, filed Oct. 24, 2012, entitled “MOBILE DEVICE AUTOMOBILE ACCESSORY SELECTION SYSTEM,” to the same inventor herein and claims the priority benefit of that filing date. Application No. 61/718,123 is incorporated by reference.

### FIELD OF THE INVENTION

The present invention relates to methods for point-of-sale purchases using a mobile device such as a tablet computer.

### BACKGROUND OF THE INVENTION

Point-of-sale computer applications have been available for some time, but are lacking in certain respects for use on the premises of an automobile sales floor. This is particularly true with respect to providing point-of-sale automated tools directed to automobile accessory selections. Such selections or options are various and confusing to many potential buyers when presented in conventional settings such as brochures which are often employed to no positive effect.

Available computer applications for automobile sales are limited to table top displays and do not provide a mobile device for point-of-sale presentations to a potential buyer. Large displays are required because the displays are usually crowded with multiple tables of cost data and the like and are tailored for use by professional finance personnel. Other applications used in the industry for up-selling customers on accessories display actual color swatches, wheels and interior leather or cloth options using photographic and other life-like graphic representations.

One point-of-sale method is disclosed in US Application Publication Number US2010138289 (A1), published on Jun. 3, 2010, and entitled “Point-of-Sale Method, Terminal, and Computer-Readable Medium.” There disclosed is a method where a point-of-sale terminal may generate transaction information for a commercial transaction, the transaction information including customer information and purchase information. The point-of-sale method is directed to providing nutritional information and advertising content.

Another method is disclosed in US Application Publication Number US2010106602 (A1) published Apr. 29, 2010 and entitled “Locatable Shopping Cart and Methods for Locating the Same.” This discloses a shopping cart that can be geographically located, methods for locating such carts, and a selection system for enabling a user to create a list of items on a portable computing device, to communicate with external devices to locate each of the items available on the list within a geographically limited area, to provide users with visual or aural cues as to the location of items on the list, to progress through the list of items as each item is selected or rejected, and providing discounts toward, information about, or alternatives to the available items on the list.

Another method was disclosed in US Application Publication Number US2001007099 (A1), published Jul. 5, 2001, and entitled “Automated Single-Point Shopping Cart System and Method.” A method and apparatus creating and managing an electronic shopping cart enabling a user to shop at various merchants' web sites are described. The apparatus and method enable the creation of a central shopping cart without the need for a pre-arrangement with the merchants.

Another method was disclosed in US Application Publication Number US2005154652 (A1), published Jul. 14, 2005 and entitled “Contextual Presentation of Information About Related Orders During Browsing of an Electronic Catalog.” In this publication, an electronic catalog system, which may be implemented as a web site or another type of interactive system, presents context-sensitive account information to customers during browsing of an electronic catalog of products.

Despite the available systems, there remains a long felt, unmet need for finance managers to sell the ancillary items offered by the dealership in a consultative process. The disclosure herein meets that need by providing, for the first time, a method to present and sell automobile accessories on location with a mobile device displaying an attractive visual representation of available options that quickly presents descriptive material tied to easily comprehended icon symbology while integrating cost data with the display and transmitting the information to a buyer's contract or bill of sale, for example.

### SUMMARY OF THE DISCLOSURE

A method for mobile device automobile accessory selection including operating a mobile device to display a plurality of accessory icons on a computer screen, each icon representing a particular automobile upgrade, where each accessory icon has linked information including pricing information that will appear as a pop-up window when activated. Each icon can be moved independently, including moving off the screen entirely to reject that selection. A gridded icon with a plurality of grid locations is displayed on the computer screen, where each grid location is adapted to accept a relocated accessory icon, where the gridded icon has the shape of a car overlayed with a representation of a smart phone and the smart phone includes the plurality of grid locations. An accessory icon is selected by relocating it to one of the plurality of grid locations.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows an example of a high level system diagram for a mobile device automobile accessory selection system.

FIG. 2 shows an example of an initial screen display for a mobile device automobile accessory selection system.

FIG. 3 shows an example of another screen display configuration for a mobile device automobile accessory selection system showing certain selected options.

FIG. 4 shows an example of yet another screen display configuration for a mobile device automobile accessory selection system showing all options selected.

FIG. 5 shows an example of yet another screen display configuration for a mobile device automobile accessory selection system showing pop-up descriptive material for a first accessory.

FIG. 6 shows an example of yet another screen display configuration for a mobile device automobile accessory selection system showing pop-up descriptive material for a second accessory.

FIG. 7 shows an example of yet another screen display configuration for a mobile device automobile accessory selection system showing pop-up descriptive material for a third accessory.

FIG. 8 shows an example of yet another screen display configuration for a mobile device automobile accessory selection system showing pop-up descriptive material for a fourth accessory.

FIG. 9 shows an example of yet another screen display configuration for a mobile device automobile accessory selection system showing pop-up descriptive material for a fifth accessory.

FIG. 10 shows an example of yet another screen display configuration for a mobile device automobile accessory selection system showing pop-up descriptive material for a sixth accessory.

FIG. 11 shows an example of yet another screen display configuration for a mobile device automobile accessory selection system showing pop-up descriptive material for a seventh accessory.

FIG. 12 shows an example of yet another screen display configuration for a mobile device automobile accessory selection system showing pop-up descriptive material for an eighth accessory.

FIG. 13 shows an example of yet another screen display configuration for a mobile device automobile accessory selection system showing pop-up descriptive material for a ninth accessory.

FIG. 14 shows an example of yet another screen display configuration for a mobile device automobile accessory selection system showing pop-up descriptive material for a tenth accessory.

FIG. 15 shows an example of yet another screen display configuration for a mobile device automobile accessory selection system showing an example of a pricing report.

FIG. 16 schematically shows an example of a high level system flow diagram for a mobile device automobile accessory selection system.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the number of and the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The examples presented herein are for the purpose of furthering an understanding of the invention. The examples are illustrative and the invention is not limited to the example embodiments. For example, while particular examples herein are directed to an automobile accessory selection system, other applications may also be implemented using the teachings disclosed.

Unless the context requires otherwise, throughout the specification and claims which follow, the word “comprise” and variations thereof, such as, “comprises” and “comprising” are to be construed in an open, inclusive sense that is as “including, but not limited to.”Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### Definitions

Generally, as used herein, the following terms have the following meanings when used within the context of automobile sales or marketing processes using computer software applications:

“Automobile accessories” refer to products or services related to the purchase of an automobile, often also called “options” or “upgrades.”

“Linked” means an instruction carried out by a computer element that connects one part of a program or an element on a list to another program or list

“Mobile device” as used herein means a variety of devices that allow people to access data and information from substantially any location. The term includes cell phones, smart phones and portable devices such as tablet computers, personal data assistants lap top computers, note book computers and similar devices. Such devices are commercially available through companies like Apple Inc., USA as sold under the brand name iPad®.

“Touch screen” refers to an electronic visual display that can detect the presence and location of a touch within the display area. The term generally refers to touching the display of the device with a finger, stylus or hand. Touch screens can also sense other passive objects, such as a stylus or the like.

### Example Embodiments

In brief, the here described mobile device automobile accessory selection system changes the financial sales process during a vehicle purchase from the industry standard columnar menu system to a digital interactive process. Where the menu system has the title and description of the product or service, the mobile device automobile accessory selection system includes a plurality of accessory icons which are the gateway to more detailed information about the particular service or product. The accessory icons can be moved about including into a shopping cart location which resembles a vehicle which has a smart phone as a body panel. While a paper menu is static with three or four default groupings of products, the presently described system is dynamic allowing the finance manager and the vehicle purchaser greater flexibility of customizing the particular ancillary products desired by the vehicle purchaser and recommended by the finance manager.

In operation, the automobile accessory selection system may comprise a software application or computer program installed on a mobile device that uses icons to represent each product or service offered. For example, a vehicle service contract may be represented by a pictorial icon depicting the concept of repairs to a vehicle, while a graphic depiction of a brake pedal may be used to depict needing a brake inspection, pad replacement, rotors replacement and or all the associated labor with such a repair in the service department. The icon can be moved by graphic interface to a selection location or bin such as a shopping cart that is represented by a vehicle.

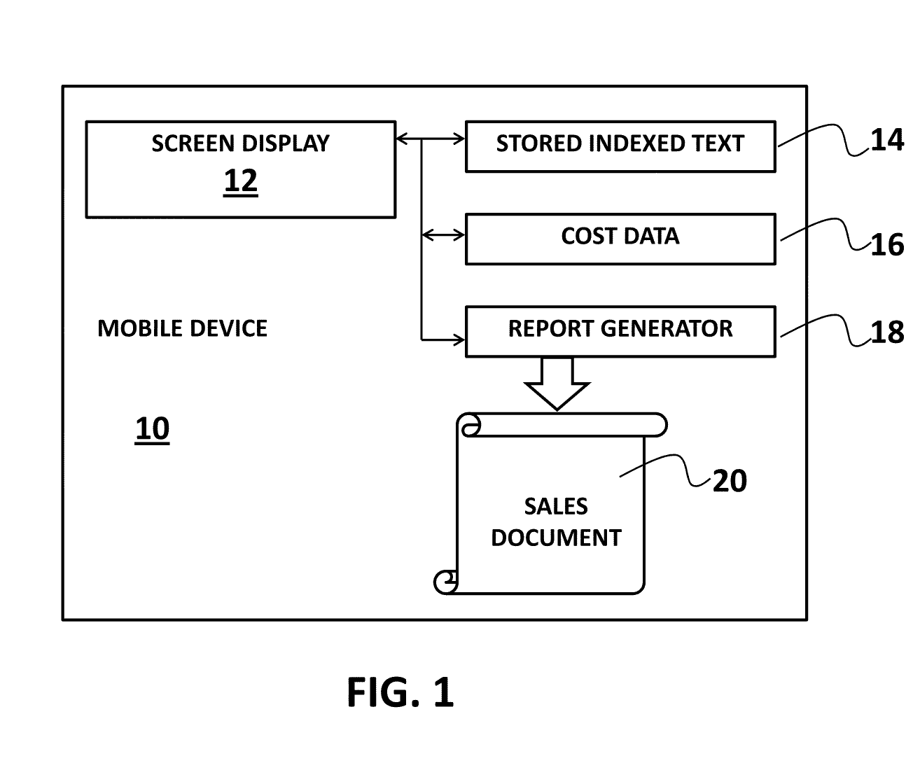

Referring now to FIG. 1 an example of a high level system diagram for a mobile device automobile accessory selection system is schematically shown. A mobile device 10 includes a screen display 12, stored indexed text 14, cost data 16 and a report generator 18. In one example the mobile device 10 may comprise one of a variety of devices that allow people to access data and information from any location where wired or wireless signals are available connecting the device to telephone networks, the Internet, an intranet or the like. Useful mobile devices include cell phones, smart phones and portable devices such as tablet computers, personal data assistants lap top computers, note book computers and similar devices. Such devices are commercially available through companies like Apple Inc., USA as sold under the brand name iPad®.

The stored indexed text 14 may be customized uniquely for each franchise and/or location and advantageously stored in a memory device in the mobile device or remotely connected to the mobile device. The stored indexed text is linked to a plurality of available options as described below and used, for example in pop-up windows when a selected accessory icon is activated. Similarly cost data may optionally be included in memory for the plurality of options. In operation as options are selected the report generator 18 may produce a draft proposal, a sales document 20 or an authorization request or other such object in digital form which may also be printed if needed. Information from the cost data, stored indexed text and other standard form data may be included in generated reports as desired by the user.

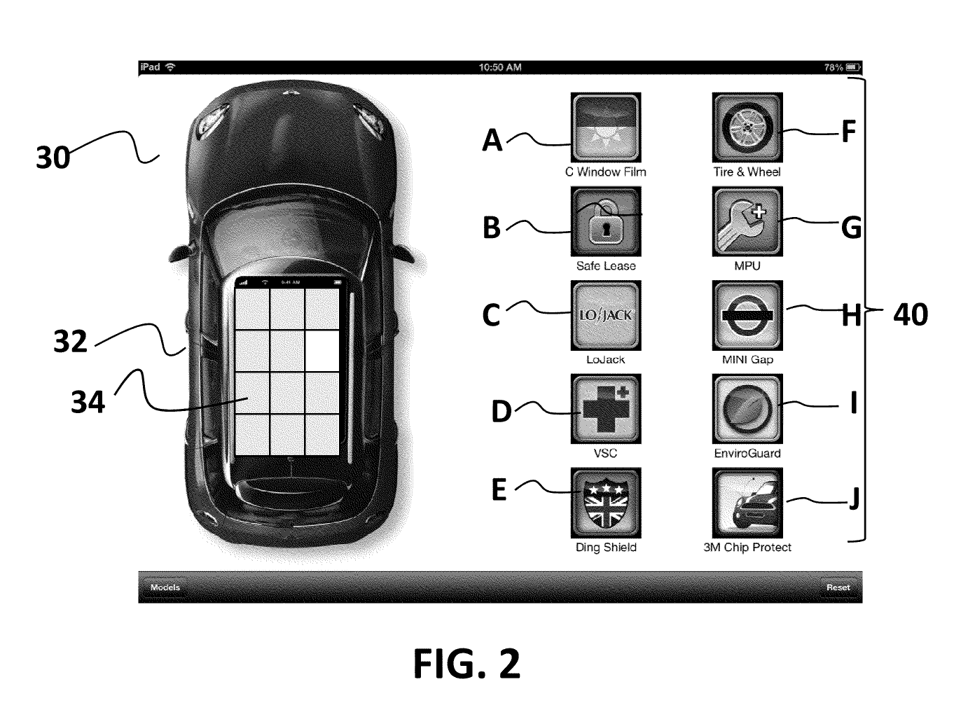

Referring now to FIG. 2, an example of an initial screen display for a mobile device automobile accessory selection system is shown. The display includes icons of an automobile model which operates as a vehicle shopping cart 30 and a plurality of automobile accessories 40. The plurality of automobile accessories 40 may comprise products or services related to the purchase of an automobile. The vehicle shopping cart 30 may have a phone icon 32 representing, for example, a smart phone or cell phone superimposed on the top of the vehicle. The phone icon 32 serves as a place holder for selected accessories. The phone icon 32 may optionally have a grid pattern 34 superimposed over it to guide placement of accessory icons for selected automobile accessories 40. In one useful embodiment a software program imbedded in the mobile device snaps any selected accessory icon into a predetermined position on the display, wherever placed to maintain symmetry of the display. Ten icons appear for illustrative purposes only and this does not imply a finite amount of available services.

In one useful embodiment the automobile accessories may include a window film accessory A, a lease safeguard for wear and tear B, a location device option C, an extended protection warranty D, a service contract for surface protection and/or repair, called a “ding shield” E, tire and wheel protection F, a maintenance upgrade service G, supplemental insurance H, environmental sealant I, chip protection J and other options that are available at the time of purchase.

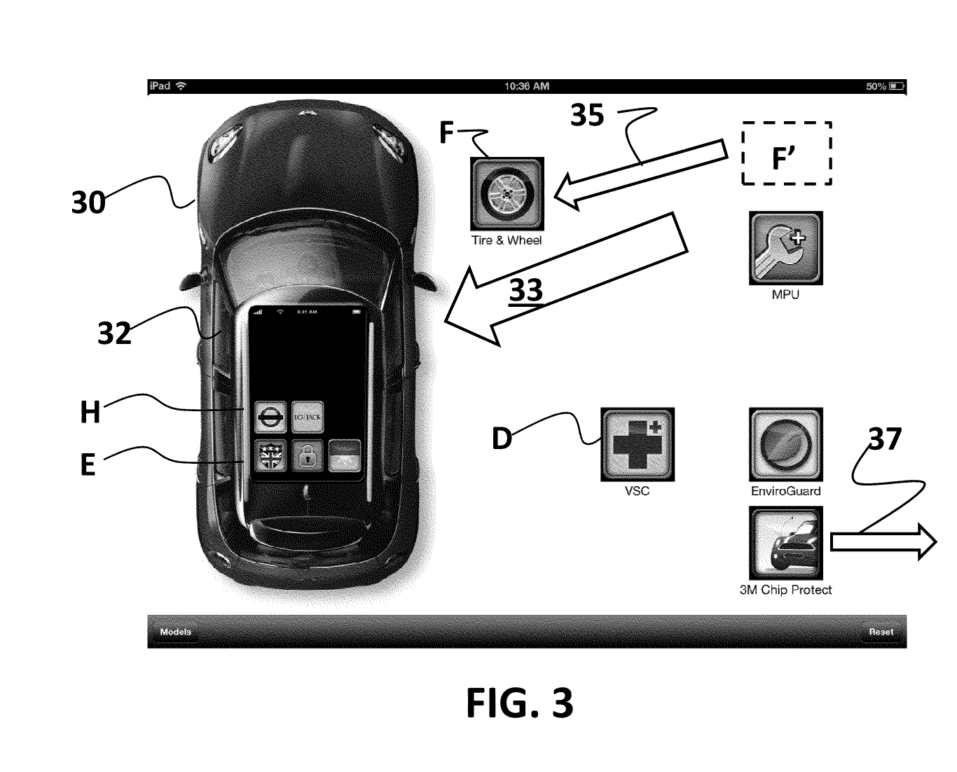

Referring now to FIG. 3 an example of another screen display configuration for a mobile device automobile accessory selection system showing certain selected options is shown. Here several options including options H and E have been selected by the purchaser and moved into the vehicle shopping cart 30. Other options, including options D and F have not been selected. Option D remains in its original position. Option F has been moved to a previously empty location for further discussion or consultation purposes.

Selected options are moved by, for example, placing a finger or stylus over the selected accessory icon and sliding it anywhere on the screen, so as to separate the item being discussed uniquely before moving it further into the vehicle shopping cart 30 as indicated by arrow 33. For example, item F has been moved from original location F′ to a separate location as indicated by arrow 35. An item may also be moved off the screen completely as indicated by arrow 37.

In one useful embodiment, the automobile accessories may seem to change the appearance of the vehicle shopping cart, for example if window film accessory A is chosen by moving the icon into the vehicle shopping cart, the windows of the graphically displayed vehicle shopping cart may turn darker illustrating the concept of the window tinting.

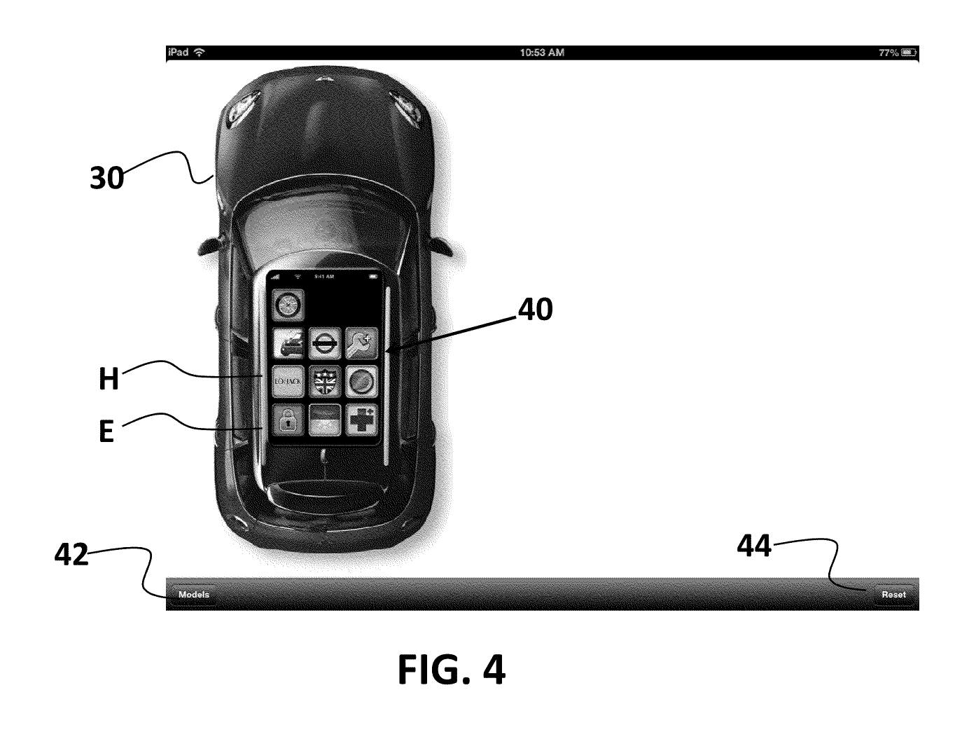

Referring now to FIG. 4, an example of yet another screen display configuration for a mobile device automobile accessory selection system showing all options selected is shown. Here the plurality of options 40 are all moved into the vehicle shopping cart 30 indicating that all options are to be purchased. Note that generally present on the display are two buttons. A first button 42 may be activated to change the model and/or color of the vehicle shopping cart 30 to match the model and/or color being considered for purchase. A second button 44 may be a reset button that returns the display to an initial condition, such as is shown in FIG. 2.

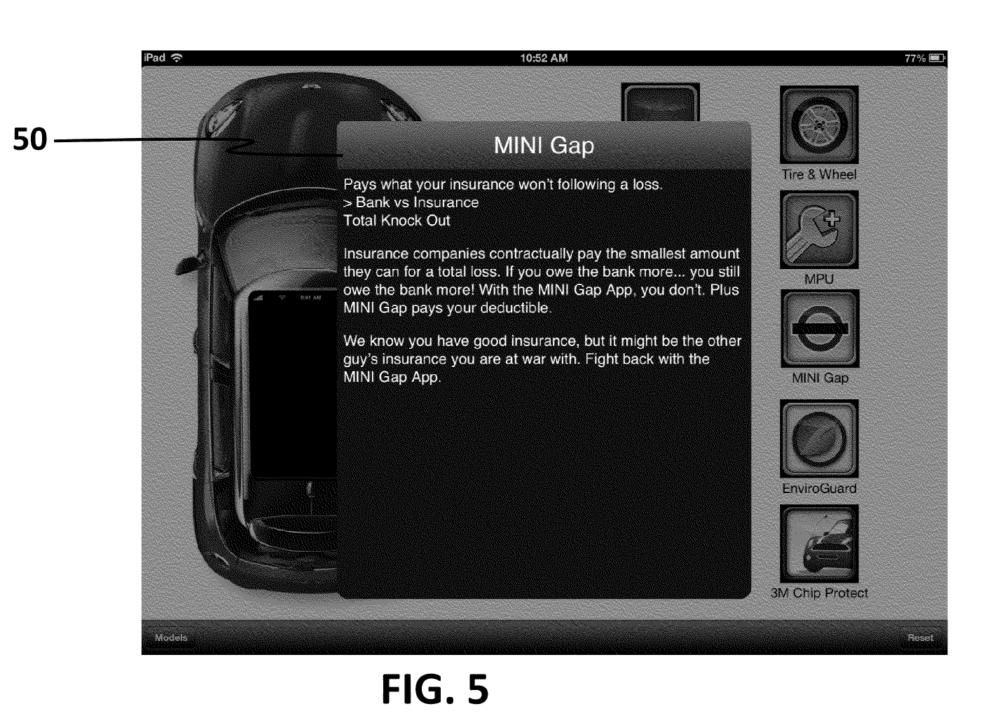

Referring now to FIG. 5, an example of yet another screen display configuration for a mobile device automobile accessory selection system showing pop-up descriptive material for a first accessory is shown. Here a pop-up window 50 containing text is activated by touching the option represented by accessory icon H.

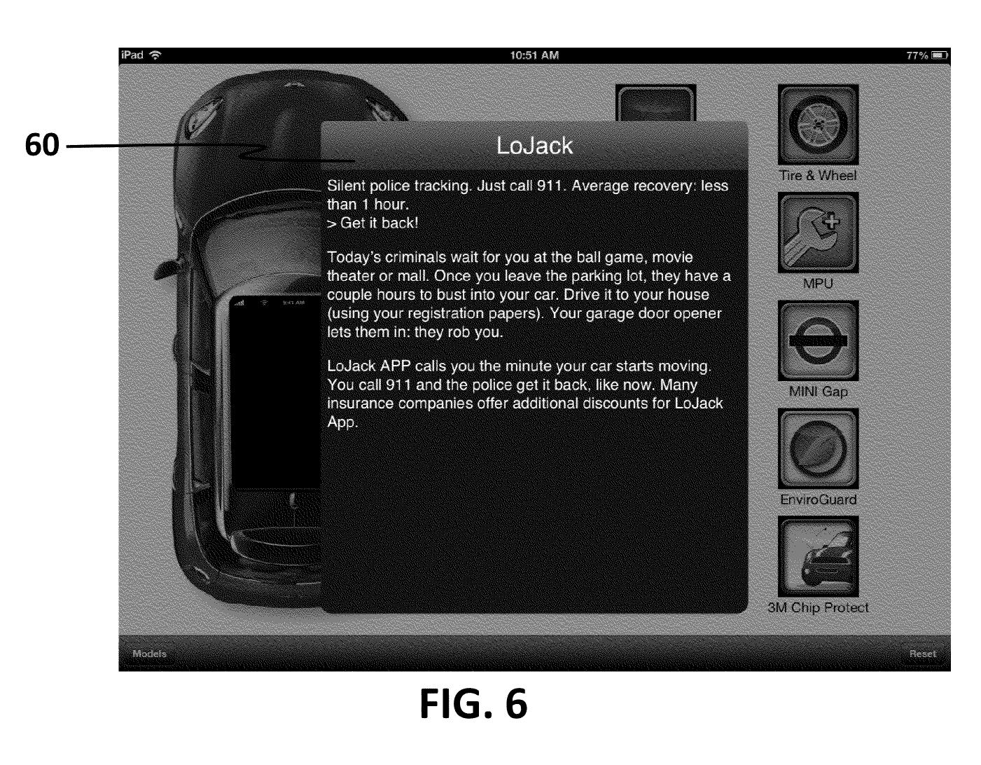

Referring now to FIG. 6 an example of yet another screen display configuration for a mobile device automobile accessory selection system showing pop-up descriptive material for a second accessory is shown. Here a pop-up window 60 containing text is activated by touching the option represented by accessory icon C.

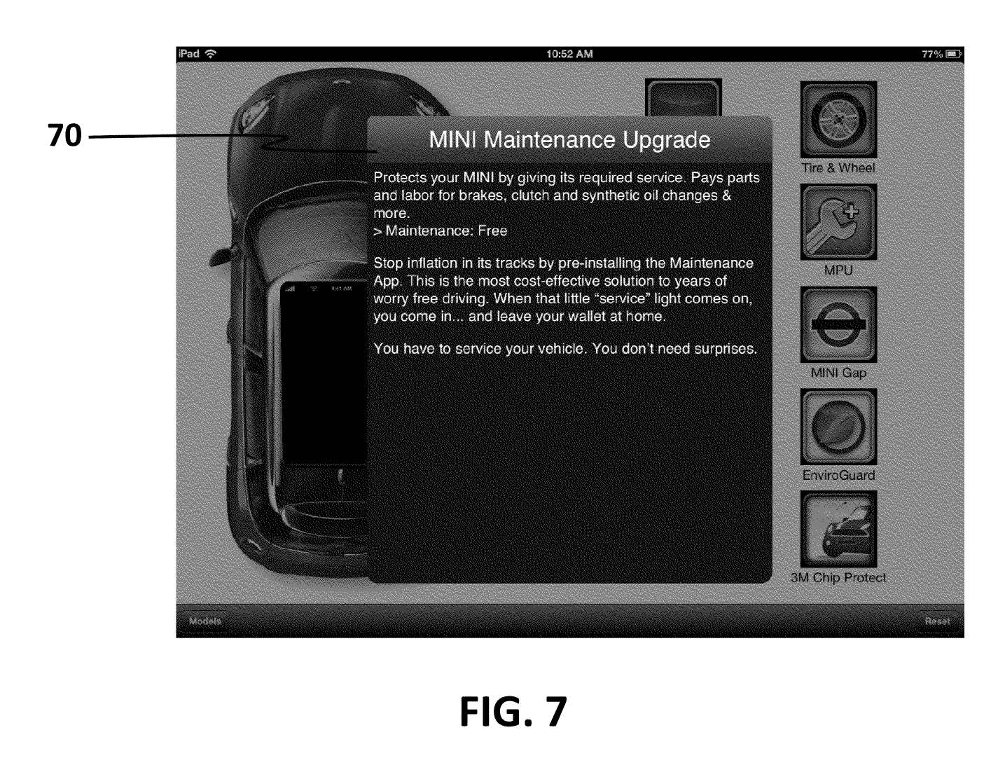

Referring now to FIG. 7, an example of yet another screen display configuration for a mobile device automobile accessory selection system showing pop-up descriptive material for a third accessory is shown. Here a pop-up window 70 containing text is activated by touching the option represented by accessory icon G.

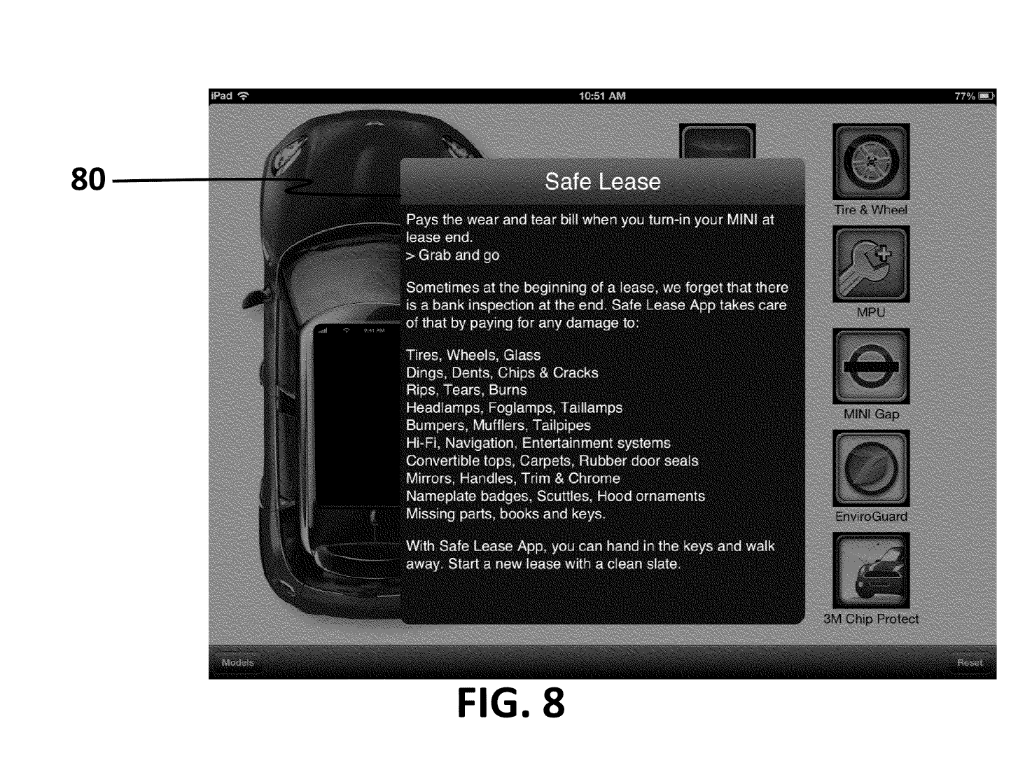

Referring now to FIG. 8, an example of yet another screen display configuration for a mobile device automobile accessory selection system showing pop-up descriptive material for a fourth accessory is shown. Here a pop-up window 80 containing text is activated by touching the option represented by accessory icon B.

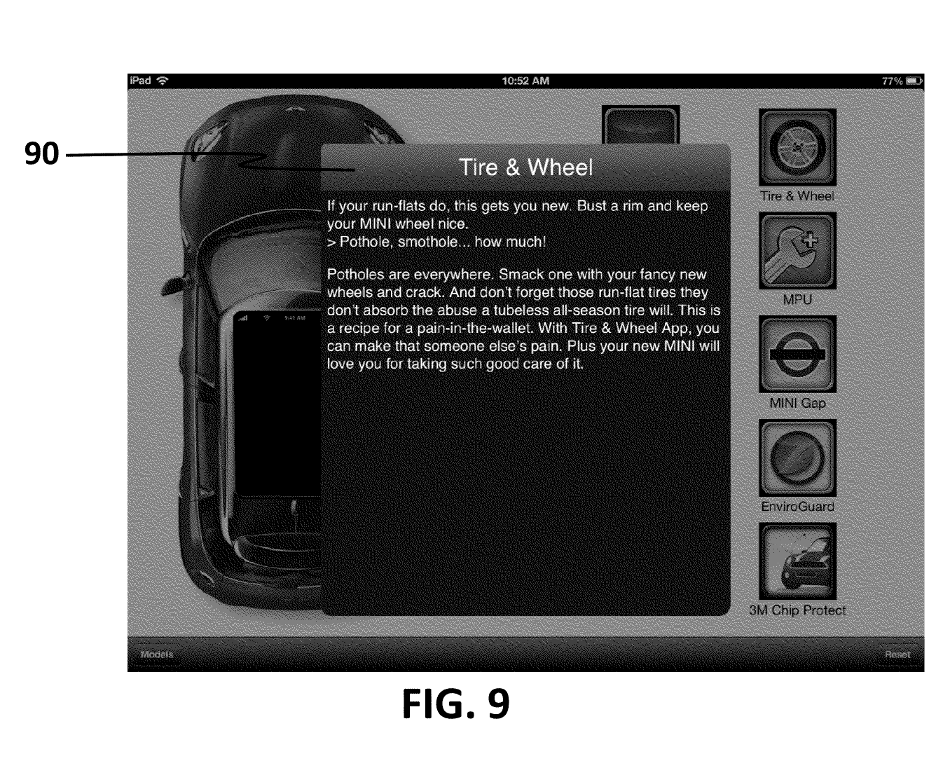

Referring now to FIG. 9, an example of yet another screen display configuration for a mobile device automobile accessory selection system showing pop-up descriptive material for a fifth accessory is shown. Here a pop-up window 90 containing text is activated by touching the option represented by accessory icon F.

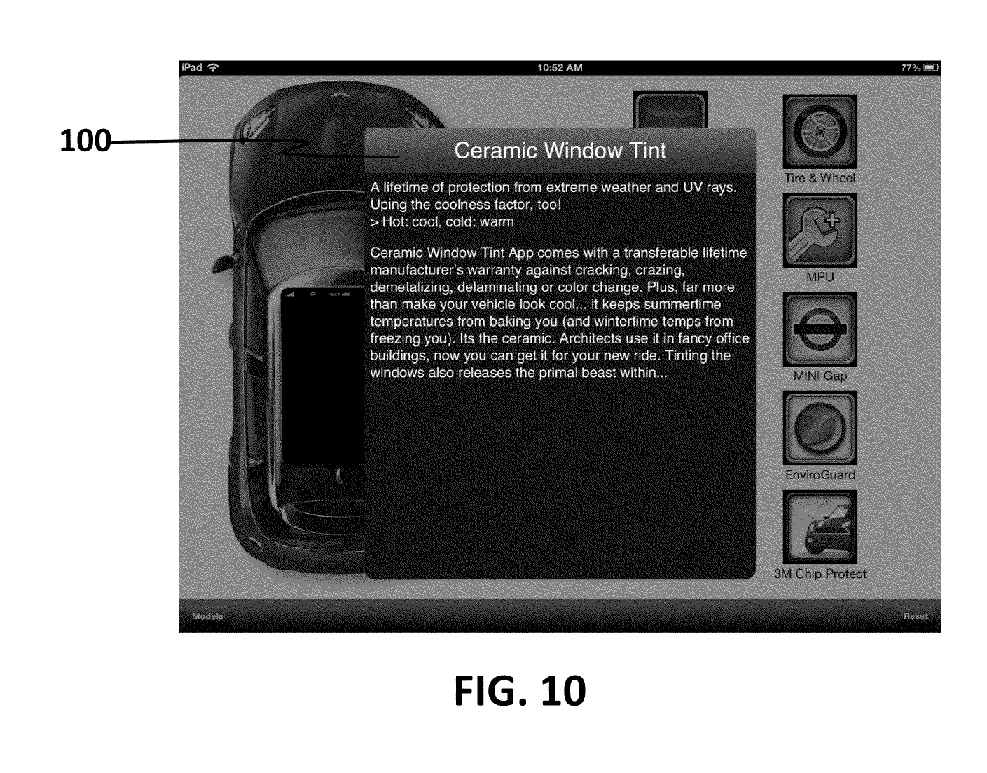

Referring now to FIG. 10, an example of yet another screen display configuration for a mobile device automobile accessory selection system showing pop-up descriptive material for a sixth accessory is shown. Here a pop-up window 100 containing text is activated by touching the option represented by accessory icon A.

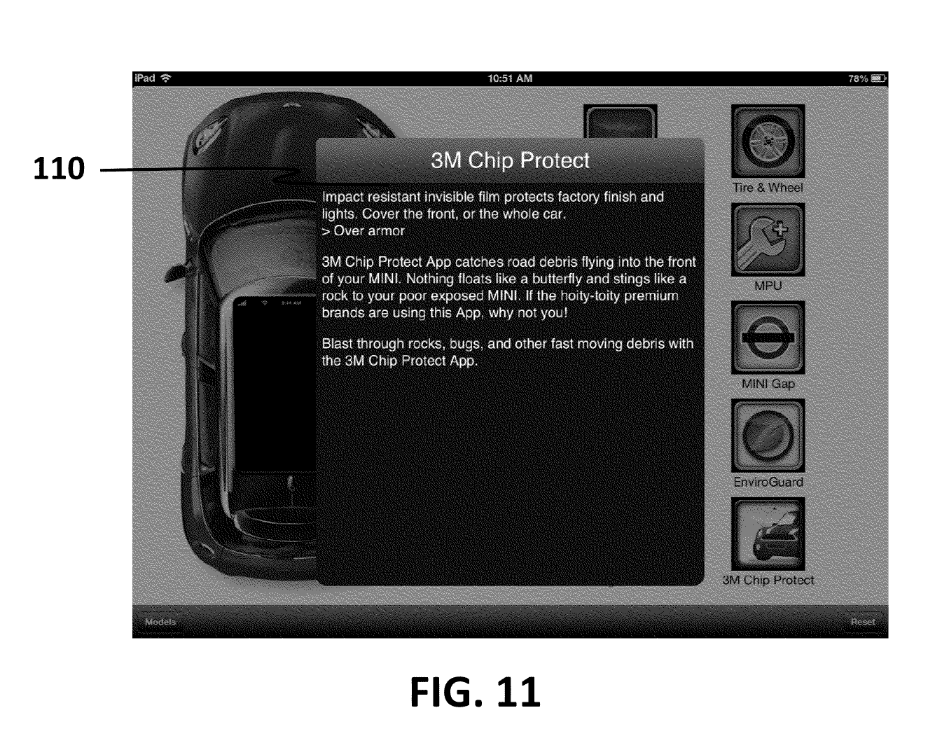

Referring now to FIG. 11, an example of yet another screen display configuration for a mobile device automobile accessory selection system showing pop-up descriptive material for a seventh accessory is shown. Here a pop-up window 110 containing text is activated by touching the option represented by accessory icon J.

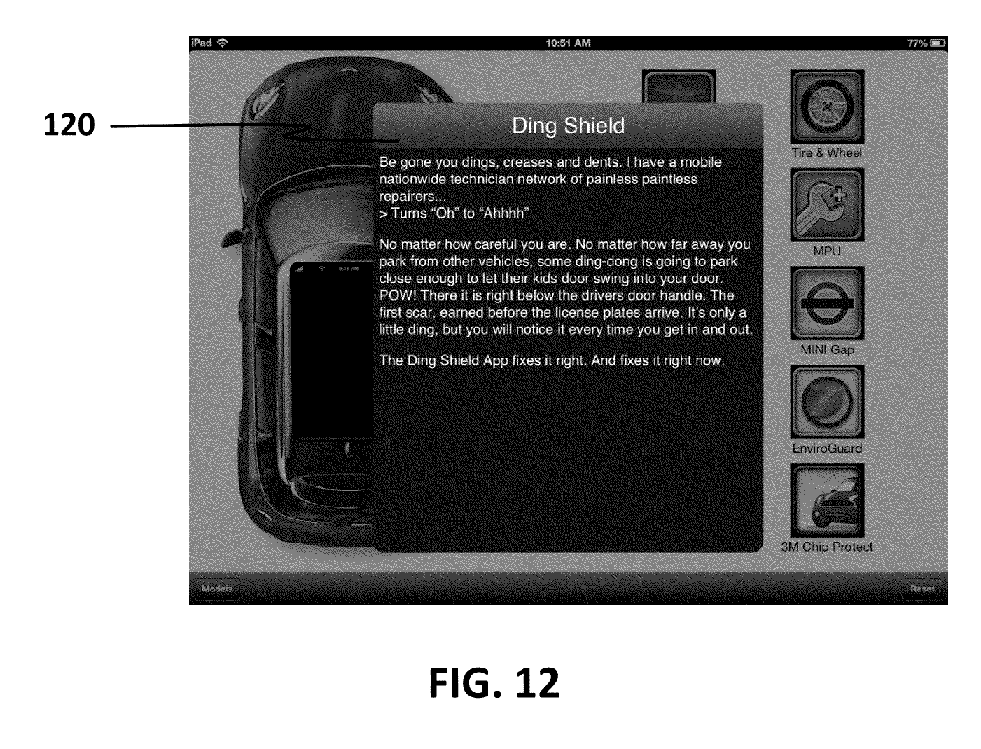

Referring now to FIG. 12, an example of yet another screen display configuration for a mobile device automobile accessory selection system showing pop-up descriptive material for an eighth accessory is shown. Here a pop-up window 120 containing text is activated by touching the option represented by accessory icon E.

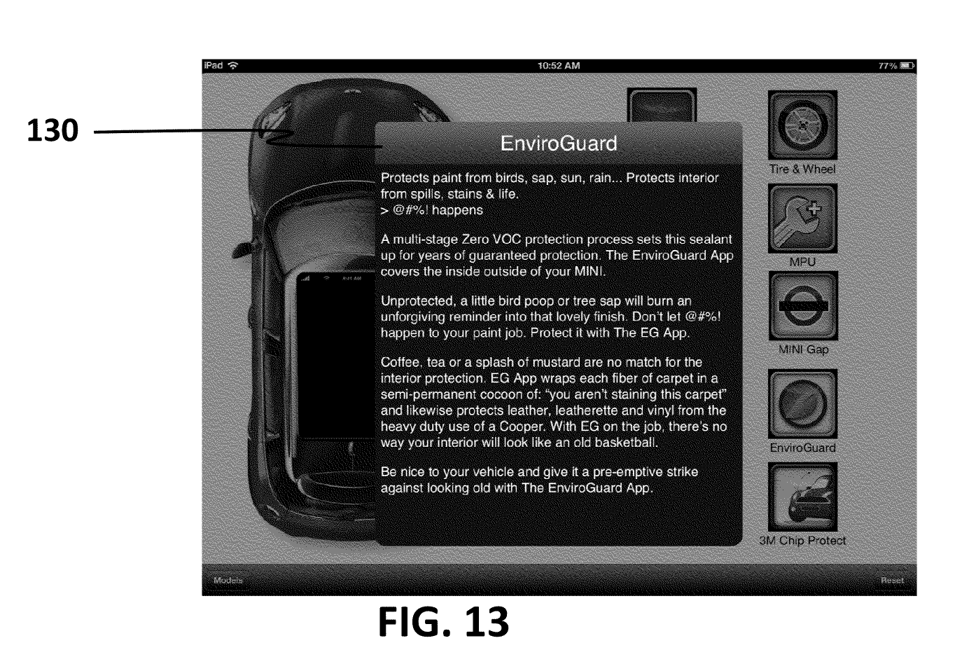

Referring now to FIG. 13, an example of yet another screen display configuration for a mobile device automobile accessory selection system showing pop-up descriptive material for a ninth accessory is shown. Here a pop-up window 130 containing text is activated by touching the option represented by accessory icon I.

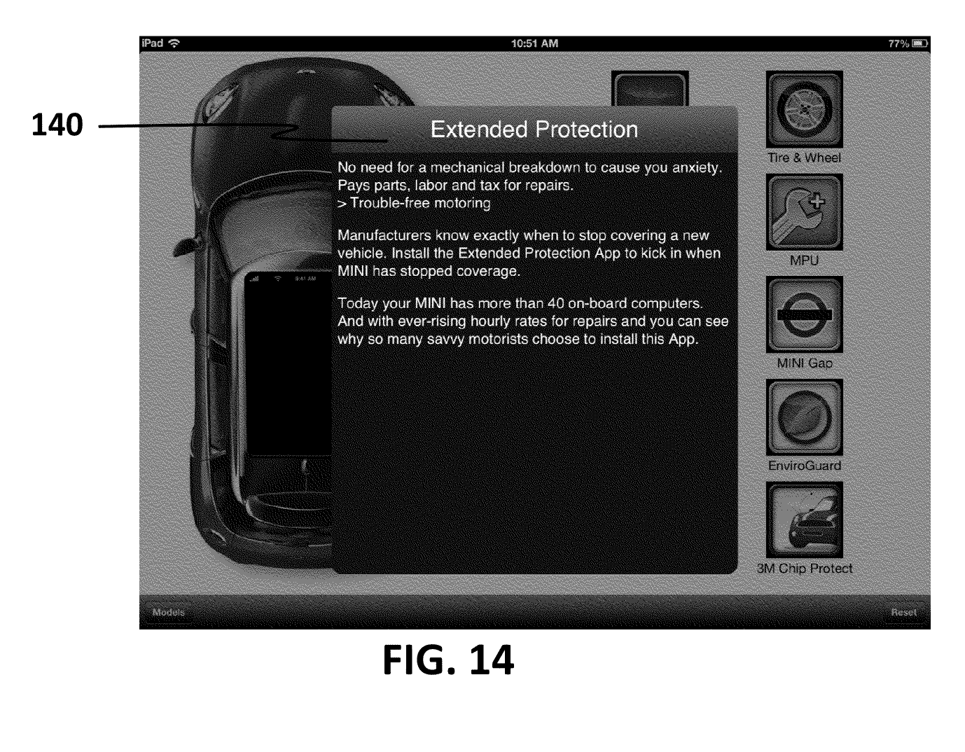

Referring now to FIG. 14, an example of yet another screen display configuration for a mobile device automobile accessory selection system showing pop-up descriptive material for a tenth accessory is shown. Here a pop-up window 140 containing text is activated by touching the option represented by accessory icon H.

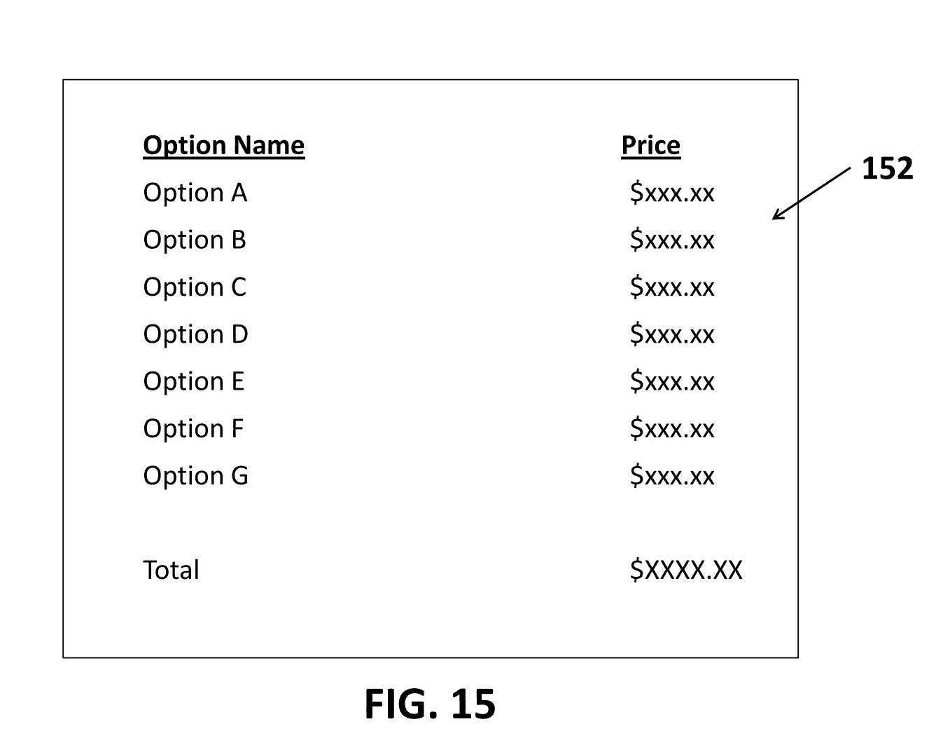

Referring now to FIG. 15, an example of yet another screen display configuration for a mobile device automobile accessory selection system showing an example of a pricing report is shown. A pricing report 152 may include textual data such as the option name and description and relate the option to net costs, gross costs (after taxes, labor and shop fees) and/or monthly installment increases for a lease or time-purchase. The report can be integrated into the sales document 20 or simply presented to a purchaser for consideration before contracting to purchase anything. Using standard software techniques the shopping cart information can be translated into this report or other reports and documents as needed.

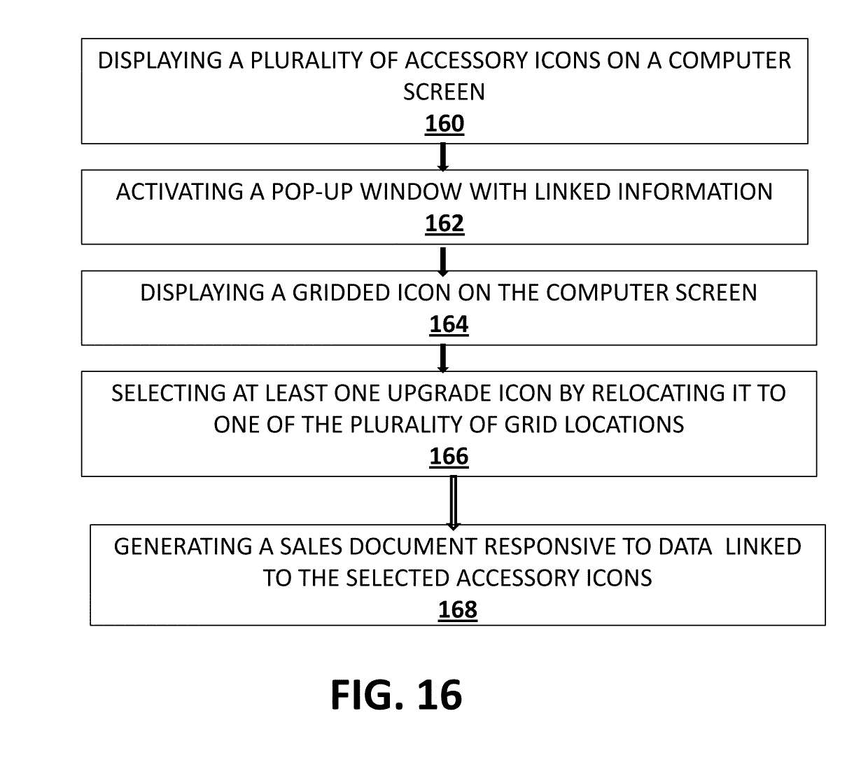

Referring now to FIG. 16, an example of a high level system flow diagram for a mobile device automobile accessory selection system is schematically shown. The method includes displaying a plurality of accessory icons on a computer screen 160, each accessory icon representing a particular automobile upgrade, where each accessory icon has linked information including pricing information that will appear as a pop-up window when activated. Optionally, a pop-up window with linked information can be activated to show information linked to each accessory icon 162. A gridded icon with a plurality of grid locations on the computer screen is displayed 164, where each grid location is adapted to accept a relocated accessory icon, where the gridded icon has the shape of a car overlayed with a representation of a smart phone and the smart phone includes the plurality of grid locations. At least one of the plurality of accessory icons is selected by relocating it to one of the plurality of grid locations 166. A sales document may optionally be generated where the information on the document reproduces data linked to the selected accessory icons 168.

In other embodiments it is contemplated that the system may include a screen display showing a car model as selected by a buyer and the application of an accessory to the car model in various rotating views. For example, window tinting may be displayed as it would appear on the car model while rotating a car model icon or photograph. Varying degrees of window tinting can also be selected to show a buyer the degrees of window tinting available and how the tint would appear on the car model selected.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices and reconstruction algorithms, and that various modifications, both as to the equipment details and operating procedures, may be accomplished without departing from the true spirit and scope of the present invention.

For example, the system described herein can be applied to other applications such as for selling add-on products, service writer use for up-selling service drive customers, and sales consultant use for accessorizing a special order car or body shop estimators.

What is claimed is:

1. A method for mobile device automobile accessory selection comprising:
operating a mobile device to display a plurality of accessory icons on a computer screen, each icon representing a particular automobile upgrade, where each accessory icon has linked information including pricing information that will appear as a pop-up window when activated;
displaying a gridded icon with a plurality of grid locations on the computer screen, where each grid location is adapted to accept a relocated accessory icon, where the gridded icon has the shape of a car overlayed with a representation of a smart phone and the smart phone includes the plurality of grid locations; and
selecting at least one of the plurality of accessory icons by relocating it to one of the plurality of grid locations.

2. The method of claim 1 wherein the method further comprises activating a pop-up window by activating a selected accessory icon to show information linked to the accessory icon.

3. The method of claim 1 wherein the method further comprises generating a draft proposal, sales document, an authorization request or report where the information on the document reproduces data linked to the selected accessory icons.

4. The method of claim 3 wherein the plurality of accessory icons includes items selected from the group consisting of a window film accessory, a lease safeguard for wear and tear, a location device option, an extended protection warranty, a surface protection service, a tire and wheel protection service, a maintenance upgrade service, a supplemental insurance policy, an environmental sealant, and a chip protection product.

5. The method of claim 2 wherein each pop-up window includes descriptive text.

6. The method of claim 1 wherein each accessory icon is linked to pricing data.

7. The method of claim 1 wherein the computer screen comprises a touch screen.

8. The method of claim 1 wherein the mobile device is selected from the group consisting of a cell phone, a smart phone, a portable computer, a tablet computer, a personal data assistant, a lap top computer, and a notebook computer.

9. The method of claim 1 wherein icons are selected by touching with a finger or stylus.

10. A system for mobile device automobile accessory selection comprising:
a mobile device having a computer screen;
a program application that operated to display a plurality of accessory icons on a screen, each icon representing a particular automobile upgrade, where each accessory icon has linked information including pricing information that will appear as a pop-up window when activated, and further displaying a gridded icon with a plurality of grid locations on the computer screen, where each grid location is adapted to accept a relocated accessory icon, where the gridded icon has the shape of a car overlayed with a representation of a smart phone and the smart phone includes the plurality of grid locations; and
the program application allowing selection of at least one of the plurality of accessory icons by relocating it to one of the plurality of grid locations.

11. The system of claim 10 wherein the program application further operates to activate a pop-up window when a user activates a selected accessory icon.

12. The system of claim 10 wherein the application further includes a report generating program for generating a draft proposal, sales document, an authorization request or report where the information on the document reproduces data linked to the selected accessory icons.

13. The system of claim 12 wherein each pop-up window includes descriptive text.

14. The system of claim 10 wherein the plurality of accessory icons includes items selected from the group consisting of a window film accessory, a lease safeguard for wear and tear, a location device option, an extended protection warranty, a surface protection service, a tire and wheel protection service, a maintenance upgrade service, a supplemental insurance policy, an environmental sealant, and a chip protection product.

15. The system of claim 10 wherein each accessory icon is linked to pricing data.

16. The system of claim 10 wherein the computer screen comprises a touch screen.

17. The system of claim 10 wherein the mobile device is selected from the group consisting of a cell phone, a smart phone, a portable computer, a tablet computer, a personal data assistant, a lap top computer, and a notebook computer.

18. The system of claim 10 wherein icons are selected by touching with a finger or stylus.

19. The method of claim 1 further comprising moving a selected icon to a separated location on the screen for further discussion.

20. The method of claim 1 further comprising moving a selected icon off of the screen.
